(19) United States
(12) Patent Application Publication
(10) Pub. No.: US 2007/0237068 A1
(43) Pub. Date: Oct. 11, 2007

(54) Method of providing pilot signals for uplink power control

(76) Inventors: Qi Bi, Morris Plains, NJ (US); Yifei Yuan, Livingston, NJ (US)

Correspondence Address: WILLIAMS, MORGAN & AMERSON, 10333 RICHMOND, SUITE 1100, HOUSTON, TX, 77042, US

(21) Appl. No.: 11/399,121

(22) Filed: Apr. 6, 2006

(51) Int. Cl. H04J 11/00

(52) U.S. Cl. 370/208

(57) ABSTRACT

The present invention provides a method of communication involving a plurality of orthogonal tones. The method includes transmitting at least one first pilot symbol using at least one first tone selected from the plurality of orthogonal tones. The first pilot symbol is associated with data transmitted using at least one second tone selected from the plurality of orthogonal tones.

### BACKGROUND OF THE INVENTION

1. Field of the Invention

This invention relates generally to communication systems, and, more particularly, to wireless communication systems.

2. Description of the Related Art

A conventional wireless communication system includes one or more access points that provide wireless connectivity to mobile units. The access points may include base stations, base station routers, access networks, and the like, and the mobile units may include cellular telephones, personal data assistants, smart phones, text messaging devices, pagers, network interface cards, notebook computers, desktop computers, and the like. The mobile units and the access points communicate by exchanging information over an air interface (or wireless communication link) that typically includes a number of channels, such as traffic channels, signaling channels, paging channels, and the like.

Channels of the air interface are defined according to the wireless communication protocol or protocols being used by the wireless communication system. For example, the channels of an air interface that operates according to Code Division Multiple Access (CDMA) are defined by orthogonal codes that modulate radio signals that are used to transmit information over the air interface. The channels of the air interface may also be determined by frequencies of the carrier waves used to transmit information over the air interface. For example, in orthogonal frequency division multiplexing (OFDM), which may also be referred to as Orthogonal Frequency Division Multiple Access (OFDMA), one or more mobile units may share a plurality of orthogonal frequencies, or tones, which may be used for transmitting information.

In an OFDM system, each mobile unit may transmit using one or more tones for a certain time, known as a dwell. For example, a subframe may be divided into a number of dwells and each dwell is divided into a number of time slots that each may transmit one symbol. The mobile unit may then hop to another tone to transmit symbols for another dwell. The hopping pattern through the tones is typically random to average interference. Since the tones used for reverse link transmission to each access point are orthogonal and frequency hopping may be random, systems that implement OFDM tend to be robust against inter-symbol interference (ISI), have negligible intra-cell interference, and may allow efficient fast Fourier transform (FFT) algorithms to be used. Thus, OFDM may be implemented in high-data rate systems such as wireless local area networks, digital audio/video broadcasting, asymmetric digital subscriber lines (ADSLs), and systems that operate according to the IEEE 802.16 WiMAX and IEEE 802.20 standards.

The power used by each mobile unit to transmit signals over the channels of the air interface is typically controlled by the access point. For example, mobile units that operate according to CDMA protocols continuously transmit power control pilot signals that the access point may use to control the transmission power over the uplink (or reverse link) channels. In fully-loaded case, systems that operate according to protocols such as CDMA tend to be interference power-limited, i.e., the total received power summed over all mobiles for both signaling and traffic channels may constrain or limit the total amount of information that may be successfully carried by the system. Thus, CDMA systems may implement techniques for conserving transmission power. For example, the CDMA power control pilot signals may be transmitted at a much lower power than the traffic signals so that the overall uplink capacity is not significantly reduced by the overhead associated with transmitting the power control pilot signals.

Systems that use orthogonal frequencies to transmit information, such as OFDM, tend to be tone-limited, i.e., the number of available tones may constrain or limit the amount of information that may be transmitted. For example, a typical OFDM system may include a number of tones that may be used for transmitting information over the uplink to the access point. Thus, some orthogonal uplink systems do not allocate any tones for transmitting power control pilot signals and instead use a loose estimation of channel quality for relatively slow power adjustments. However, these techniques are not able to compensate for fast fading and therefore may result in very poor coverage and low system capacity.

Alternatively, each dwell that is used to transmit data may also include one or more embedded channel estimation pilot symbols that may be used for power control. For example, each dwell may include some symbols for data and some symbols for embedded channel estimation pilot signals. However, since the channel estimation pilot symbols are transmitted using the same tones as the data, no channel estimation pilot symbols are transmitted when no data is transmitted. Thus, the embedded channel estimation pilot symbols may not be continuous, which may make the signal strength estimation based on the channel estimate pilot symbols less accurate and may reduce the effectiveness of the power control algorithm. This problem may be particularly acute when the traffic is bursty and relatively long times may pass between data bursts, such as in Voice over Internet Protocol (VoIP), File Transfer Protocol (FTP), or Transmission Control Protocol/Internet Protocol (TCP/IP) protocols.

Continuous power control pilot signals may be provided in an OFDM system by reserving a portion of the frequency space for transmission according to a CDMA protocol. The power control pilot signals associated with data transmitted using one or more tones in the OFDM portion of the frequency space may then be transmitted using the CDMA portion of the frequency space. Although this approach may improve the signal strength estimation based on the continuously provided power control pilot signals, implementing the required hybrid OFDM/CDMA system is significantly more complicated than implementing either an OFDM system or a CDMA system separately. Consequently, the hybrid OFDM/CDMA system may incur significantly larger costs (relative to the OFDM and/or CDMA systems) for development, implementation, operation, and/or maintenance. Furthermore, the tones in the reserved frequency space are not available for OFDM transmissions, which may reduce throughput of the system.

### SUMMARY OF THE INVENTION

The present invention is directed to addressing the effects of one or more of the problems set forth above. The following presents a simplified summary of the invention in order to provide a basic understanding of some aspects of the invention. This summary is not an exhaustive overview of the invention. It is not intended to identify key or critical elements of the invention or to delineate the scope of the invention. Its sole purpose is to present some concepts in a simplified form as a prelude to the more detailed description that is discussed later.

In one embodiment of the present invention, a method is provided for communication involving a plurality of orthogonal tones. The method includes transmitting at least one first pilot symbol using at least one first tone selected from the plurality of orthogonal tones. The first pilot symbol is associated with data transmitted using at least one second tone selected from the plurality of orthogonal tones.

### BRIEF DESCRIPTION OF THE DRAWINGS

The invention may be understood by reference to the following description taken in conjunction with the accompanying drawings, in which like reference numerals identify like elements, and in which:

FIG. 1 conceptually illustrates one exemplary embodiment of a wireless communication system, in accordance with the present invention;

FIG. 2 conceptually illustrates one exemplary embodiment of a subframe including a plurality of dwells, in accordance with the present invention; and

FIG. 3 conceptually illustrates one exemplary embodiment of a method of providing pilot signals for uplink power control, in accordance with the present invention.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

### DETAILED DESCRIPTION OF SPECIFIC EMBODIMENTS

Illustrative embodiments of the invention are described below. In the interest of clarity, not all features of an actual implementation are described in this specification. It will of course be appreciated that in the development of any such actual embodiment, numerous implementation-specific decisions should be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

Portions of the present invention and corresponding detailed description are presented in terms of software, or algorithms and symbolic representations of operations on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, or as is apparent from the discussion, terms such as “processing” or “computing” or “calculating” or “determining” or “displaying” or the like, refer to the action and processes of a computer system, or similar electronic computing device, that manipulates and transforms data represented as physical, electronic quantities within the computer system's registers and memories into other data similarly represented as physical quantities within the computer system memories or registers or other such information storage, transmission or display devices.

Note also that the software implemented aspects of the invention are typically encoded on some form of program storage medium or implemented over some type of transmission medium. The program storage medium may be magnetic (e.g., a floppy disk or a hard drive) or optical (e.g., a compact disk read only memory, or “CD ROM”), and may be read only or random access. Similarly, the transmission medium may be twisted wire pairs, coaxial cable, optical fiber, or some other suitable transmission medium known to the art. The invention is not limited by these aspects of any given implementation.

The present invention will now be described with reference to the attached figures. Various structures, systems and devices are schematically depicted in the drawings for purposes of explanation only and so as to not obscure the present invention with details that are well known to those skilled in the art. Nevertheless, the attached drawings are included to describe and explain illustrative examples of the present invention. The words and phrases used herein should be understood and interpreted to have a meaning consistent with the understanding of those words and phrases by those skilled in the relevant art. No special definition of a term or phrase, i.e., a definition that is different from the ordinary and customary meaning as understood by those skilled in the art, is intended to be implied by consistent usage of the term or phrase herein. To the extent that a term or phrase is intended to have a special meaning, i.e., a meaning other than that understood by skilled artisans, such a special definition will be expressly set forth in the specification in a definitional manner that directly and unequivocally provides the special definition for the term or phrase.

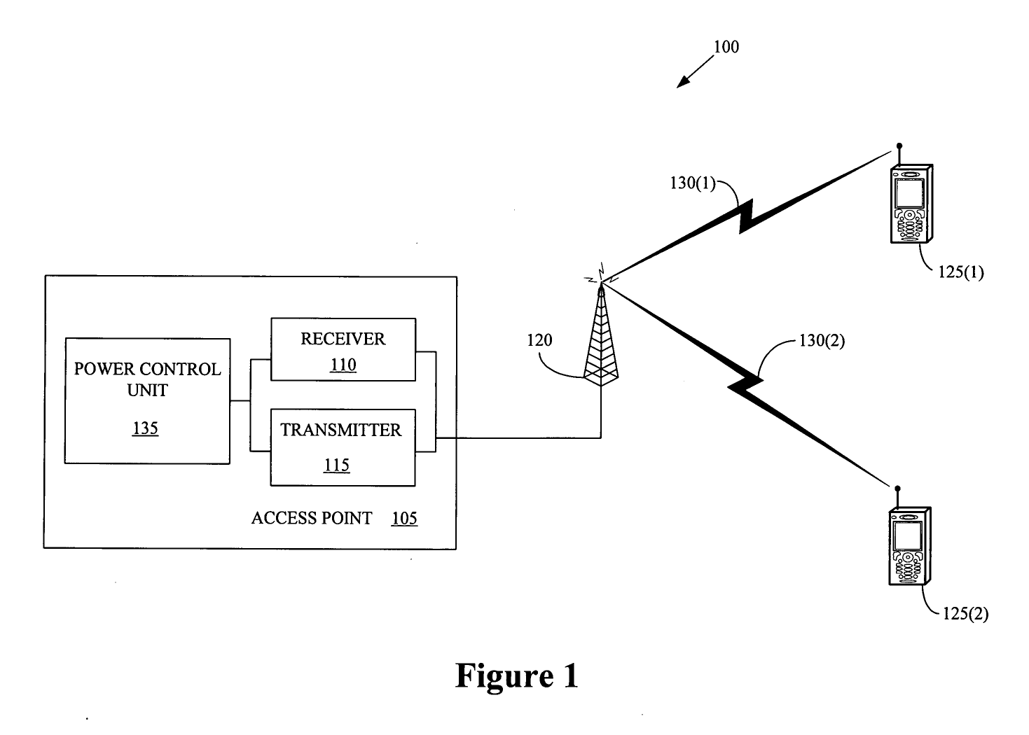

FIG. 1 conceptually illustrates one exemplary embodiment of a wireless communication system 100. In the illustrated embodiment, the wireless communication system 100 includes at least one access point 105 for providing wireless connectivity. Although the term “access point” may refer to a specific type of device in some types of wireless communication systems 100, as used herein the term “access point” will be understood to refer to any entity (or combination of entities) that is used to provide wireless connectivity. Accordingly, exemplary access points 105 may include base stations, base station routers, access networks, and the like.

The access point 105 provides wireless connectivity according to an Orthogonal Frequency Division Multiplexing (OFDM, OFDMA) protocol. Accordingly, the access point 105 may be configured to transmit and/or receive information using one or more orthogonal frequencies, or tones, selected from a set including a plurality of tones. Techniques for defining the set of tones, selecting one or more tones, and/or communicating using the orthogonal tones are known in the art and in the interest of clarity only those aspects of orthogonal frequency division multiplexing that are relevant to the present invention will be discussed in detail below. Persons of ordinary skill in the art having benefit of the present disclosure should appreciate that the access point 105 may also implement other protocols. Exemplary wireless communication protocols that may be implemented by the access point 105 include, but are not limited to, protocols defined by the Universal Mobile Telecommunication System (UMTS) standards, Code Division Multiple Access (CDMA) protocols, Frequency Division Multiple Access (FDMA) protocols, and the like.

In the illustrated embodiment, the access point 105 includes a receiver 110 and a transmitter 115 that are communicatively coupled to an antenna 120. The receiver 110 is configured to receive signals detected by the antenna 120 and the transmitter 115 is configured to provide signals for transmission via the antenna 120. For example, the receiver 110 and the transmitter 115 may include circuitry for detecting, decoding, encoding, modulating, and other operations related to transmitting and receiving signals. Although the receiver 110 the transmitter 115 are depicted as separate entities in FIG. 1, persons of ordinary skill in the art having benefit of the present disclosure should appreciate that this is not necessary for the practice of the present invention. In one alternative embodiment, the receiver 110 and the transmitter 115 may be implemented in a single entity, such as a transceiver.

The wireless communication system 100 includes one or more mobile units 125(1-2) that may communicate with the access point 105 over air interfaces 130(1-2). The indices (1-2) may be dropped when referring to the mobile units 125 and/or air interfaces 130 collectively. However, the indices (1-2) may be used to indicate individual mobile units 125 and/or air interfaces 130, or subsets thereof. This convention may also be applied below to other elements indicated by a numeral and one or more indices. The mobile units 125 and the air interfaces 130 are configured to support communications that implement orthogonal frequency division multiplexing techniques. For example, the mobile unit 125(1) may use one or more tones selected from a set of tones for communicating with the access point 105 over the air interface 130(1). The mobile unit 125(2) may use a different group of tones selected from the set of tones for communicating with the access point 105 over the air interface 130(2). Accordingly, both of the mobile units 125 may communicate concurrently with the access point 105.

A power control unit 135 may be used to control the power used by the mobile units 125 to transmit information over uplink channels of the air interfaces 130. The mobile units 125 may therefore provide power control pilot signals that may be used by the power control unit 135 to control the power used by the mobile units to transmit information over uplink channels. For example, the power control unit 135 may determine a power control instruction (e.g., an instruction indicating that one or more of the mobile units 125 should increase, decrease, or maintain its uplink transmission power) based upon the provided power control pilot signals. Information indicative of the power control instructions may then be provided to the mobile units 125 which may use the power control instructions to determine an uplink transmission power. Techniques for determining the power control instructions based on received power control pilot signals are known in the art and in the interest of clarity only those aspects of these techniques that are relevant to the present invention will be discussed further herein.

As discussed above, the mobile units 125 may transmit data concurrently using tones selected from a plurality of tones. The mobile units 125 may also transmit pilot signals using other tones selected from the plurality of tones. For example, the mobile unit 125(1) may transmit data using a first tone and the mobile unit 125 (2) may transmit data using a second tone. A third tone may then be used to transmit pilot signals associated with the data transmitted using the first and second tones. In one embodiment, the third tone includes a plurality of time slots that may be used to transmit symbols. The pilot signals associated with data transmitted by the mobile units 125 may then be transmitted in different time slots of the third tone (i.e., the pilot signals may be transmitted on a time-shared basis).

The access point 205 may determine the number of tones that may be reserved for power control pilot symbols and then transmit this information to the mobile units 125. For example, the access point 205 may transmit information indicative of the number of tones to be allocated to the power control pilot symbols through L3 signaling (i.e., over broadcast channels) in a semi-static manner. In one embodiment, a pair of power control pilot tones is time shared by 8 users. For example, if there are 36 active users in a sector, total of 10 tones have to be reserved for power control pilots. The signaling overhead is therefore expected to be low as normally the maximum number of active users in a sector is no more than 48 for 1.25 MHz bandwidth, which translates to 6 pairs of power control pilot tones at most. Therefore 3 bits are enough to signal the tone reservation for power control pilot tones.

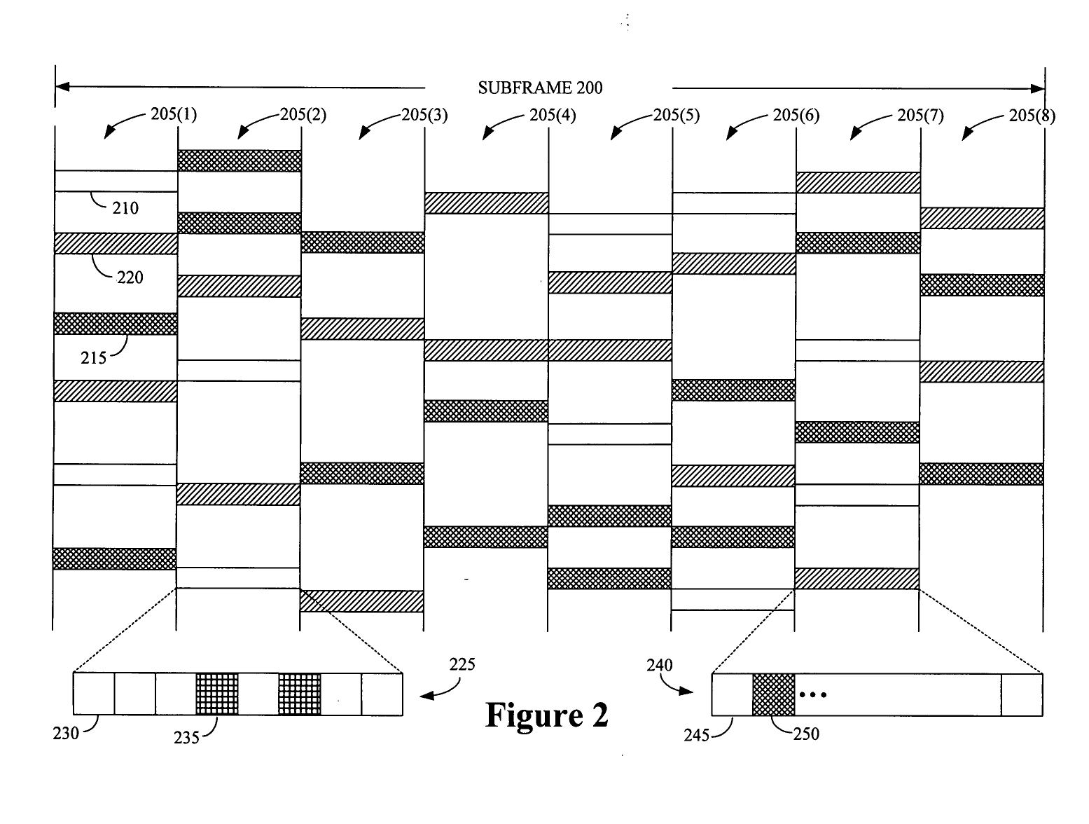

FIG. 2 conceptually illustrates one exemplary embodiment of a subframe 200 including a plurality of dwells 205. The horizontal axis in FIG. 2 indicates time and the vertical axis indicates the tones. The number of tones that may be allocated is a matter of design choice and not material to the present invention. However, a typical number of tones in the plurality of tones that are available for allocation may be about 113. In the illustrated embodiment, the subframe 200 is divided into eight dwells 205 and each dwell 205 is subdivided into eight time slots so that each tone may transmit up to 64 symbols during the subframe 200. The subframe 200 has a duration of about 6.67 ms.

The open boxes 210 (only one indicated by a numeral in FIG. 2) indicate tones that are assigned or allocated to a first user for data transmission, the crosshatched boxes 215 (only one indicated by a numeral in FIG. 2) indicate tones that are assigned or allocated to a second user for data transmission, and the boxes 220 (only one indicated by a numeral in FIG. 2) that have single hatching are associated with pilot signals that may be transmitted by the first and/or second user. In the illustrated embodiment, two tones 210 are allocated to the first user, two tones 215 are allocated to the second user, and two tones 220 are allocated for pilot signals in the first dwell 205(1).

An exploded view 225 of one of the tones 210 assigned to the first user for data transmission in the second dwell 205(2) shows how the time slots may be allocated. In the illustrated embodiment, the time slots 230 (only one indicated by a numeral in FIG. 2) are allocated for symbols indicative of data being transmitted in the tone 210. For example, six of the time slots 230 may be used to transmit signals indicative of a data symbol associated with voice transmissions, e.g., data formed according to VoIP. The remaining two time slots 235 are allocated to embedded pilot symbols that may be used for channel estimation. However, persons of ordinary skill in the art should appreciate that the allocation of the time slots 230, 235 of tone 210 shown in FIG. 2 is intended to be illustrative and not to limit the present invention. In alternative embodiments, any number of the time slots 230, 235 may be allocated for data and/or channel estimation pilot symbols.

An exploded view 240 of one of the tones 220 allocated for transmitting pilot signals, such as the power control pilot signals, in the seventh dwell 205(7) shows how the time slots may be allocated. In the illustrated embodiment, the first time slot 245 in the pilot signal tone 240 is allocated to a power control pilot symbol associated with the first user and the second time slot 250 is allocated to a power control pilot symbol associated with the second user. Although not shown in FIG. 2, other tones in the subframe 200 may support other users, in which case pilot symbols associated with these other users may be allocated in the same manner as for the pilot signal tone 240.

The other pilot symbol tone(s) 220 in the seventh dwell 205(7) may also have time slots allocated to power control pilot symbols associated with the first and second users, as well as any other users that may be transmitting data in the subframe 200. Accordingly, systems implementing the pilot symbol tone allocation technique shown in the illustrated embodiment may support two-degree diversity. However, persons of ordinary skill of the art having benefit of the present disclosure should appreciate that the present invention is not limited to the illustrated tone allocation technique and, in alternative embodiments, more or fewer pilot symbol tones may be allocated to support different levels of diversity.

The tones allocated to the users and/or pilot signals may be randomly assigned in each of the dwells 205. In one time duration of the subframe 200, the user tones 210, 215, 220 hop 8 times. The purpose of tone hopping is to randomize inter-cell interference. Since the tones 220 allocated for transmitting power control pilot symbols are tone-hopped, the per-subframe averaged channel strength measured from power control pilots in the tones 220 should be close to what is actually experienced in dedicated tones 210, 215 used for data transmission, even in frequency-selective fading.

The number of tones allocated to users for data transmissions may not be constant throughout the subframe 200 or between different subframes 200. For example, in some circumstances, such as bursty transmissions associated with VoIP traffic, no data may be available for transmission by some users during one or more of the dwells 205. Accordingly, tones may not be assigned to all users during all of the dwells 205. In the illustrated embodiment, no tones are allocated to the first user during the dwells 205(3-4) and 205(8) because no data was available for transmission by the first user. Alternatively, additional tones may be allocated to one or more of the users when the amount of data for transmission increases.

Although the number of tones allocated for data transmission may vary, the number of tones 220 allocated to pilot symbols may remain constant throughout all of the dwells 205 of the subframe 200. Accordingly, the pilot symbols in the tones 220 may provide relatively continuous feedback, which may increase the accuracy of the signal strength estimation used in power control algorithms. The power control algorithms may therefore provide more accurate power control instructions, which may increase the efficiency of the wireless communication system. The power control algorithms may also be more accurate in both fast and slow fading circumstances when feedback is provided approximately continuously using the power control pilot symbols in the tones 220.

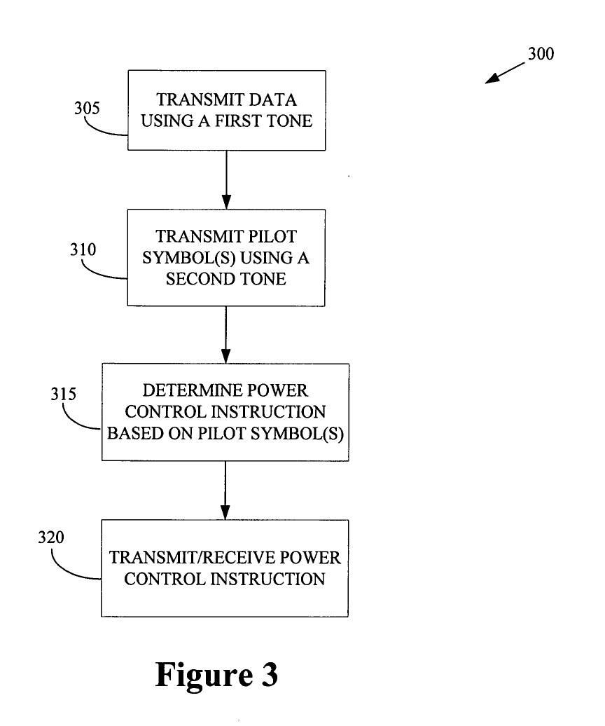

FIG. 3 conceptually illustrates one exemplary embodiment of a method 300 of providing pilot signals for uplink power control. In the illustrated embodiment, a first user transmits (at 305) data using a first allocated tone in a dwell of a subframe. As discussed above, the tone used to transmit (at 305) data may include time slots allocated to data symbols and channel estimation pilot symbols. Other users may also be transmitting (at 305) data using other allocated tones in the dwell of the subframe. The first user also transmits (at 310) one or more pilot symbols in one or more time slots of a second allocated tone in the dwell of the subframe. As discussed above, if other users are also transmitting (at 305) data, these users they also transmit (at 310) one or more pilot symbols using other time slots in the second allocated tone.

The transmitted power control pilot symbols may then be received, e.g. at an access point, which may use the transmitted pilot symbols to determine (at 315) one or more power control instructions. For example, the transmitted power control pilot symbols may be used to determine (at 315) whether the uplink transmission power for each of the users should be maintained, increased, or decreased. Information indicative of the power control instruction may then be transmitted (at 320) to one or more of the users. For example, the access point may transmit one or more bits indicating whether the uplink transmission power should be maintained, increased, or decreased. The bits may indicate a relative change in the uplink transmission power (e.g., the uplink transmission power should vary by a certain percentage of the present uplink transmission power), an absolute change in the uplink transmission power (e.g., the uplink transmission power should vary by a fixed number of watts), or no change in the uplink transmission power. One or more of the users may then received (at 320) the power control instruction and modify the uplink transmission power for subsequent transmissions accordingly.

Embodiments of the techniques described above may have a number of advantages over conventional practice. For example, very tight fast power control (relative to the conventional power control techniques described above) can be achieved in an OFDM uplink. The improved fast power control provided by embodiment of the techniques described above may be particularly useful in bursty traffic applications, which tend to provide data sporadically and yet require accurate power control to operate continuously. These advantages may be achieved with a small overhead in tone space.

The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention. Accordingly, the protection sought herein is as set forth in the claims below.

What is claimed:

1. A method of communication involving a plurality of orthogonal tones, comprising:
transmitting at least one first pilot symbol using at least one first tone selected from the plurality of orthogonal tones, said at least one first pilot symbol being associated with data transmitted using at least one second tone selected from the plurality of orthogonal tones.

2. The method of claim 1, wherein transmitting said at least one first pilot symbol comprises transmitting said at least one first pilot symbol using said at least one first tone during a first dwell of a subframe.

3. The method of claim 2, wherein transmitting said at least one first pilot symbol comprises transmitting said at least one first pilot symbol during the first dwell of the subframe such that said at least one first tone also transmits, on a time-shared basis, at least one second pilot symbol associated with data transmitted using at least one third tone selected from the plurality of orthogonal tones.

4. The method of claim 3, comprising transmitting, using said at least one second tone during the first dwell of the subframe, the data associated with said at least one first pilot symbol.

5. The method of claim 4, comprising transmitting, during the second dwell of the subframe, said at least one first pilot symbol using at least one fourth tone selected from the plurality of orthogonal tones.

6. The method of claim 5, comprising transmitting, during the second dwell of the subframe, data associated with said at least one first pilot symbol using at least one fifth tone selected from the plurality of orthogonal tones.

7. The method of claim 6, wherein transmitting said at least one first pilot symbol using said at least one fourth tone during the second dwell of the subframe comprises transmitting said at least one first pilot symbol using said at least one fourth tone during the second dwell of the subframe such that said at least one fourth tone also transmits, on a time-shared basis, at least one second pilot symbol associated with data transmitted using at least one sixth tone selected from the plurality of orthogonal tones.

8. The method of claim 1, wherein transmitting said at least one first pilot symbol comprises transmitting at least two first pilot symbols using at least two first tones, said at least two first pilot symbols being associated with data transmitted by a mobile unit using said at least one second tone.

9. The method of claim 1, comprising receiving information indicative of a power control instruction, the power control instruction being determined based on said at least one first pilot symbol.

10. A method of communication involving a plurality of orthogonal tones, comprising:
receiving at least one first pilot symbol using at least one first tone selected from the plurality of orthogonal tones, said at least one first pilot symbol being associated with data transmitted using at least one second tone selected from the plurality of orthogonal tones.

11. The method of claim 10, comprising selecting said at least one first tone from the plurality of orthogonal tones for transmission of said at least one first pilot symbol by a first mobile unit and selecting said at least one second tone from the plurality of orthogonal tones for transmission of data by the first mobile unit.

12. The method of claim 11, comprising providing information indicative of said at least one first tone and said at least one second tone to the first mobile unit.

13. The method of claim 10, wherein receiving said at least one first pilot symbol comprises receiving said at least one first pilot symbol during a first dwell of a subframe.

14. The method of claim 13, wherein receiving said at least one first pilot symbol comprises receiving, during the first dwell of the subframe, said at least one first pilot symbol and at least one second pilot symbol associated with data transmitted using at least one third tone selected from the plurality of orthogonal tones.

15. The method of claim 14, wherein receiving said at least one first pilot symbol and said at least one second pilot symbol during the first dwell of the subframe comprises receiving said at least one first pilot symbol and said at least one second pilot symbol on a timeshared basis.

16. The method of claim 15, comprising selecting at least one fourth tone from the plurality of orthogonal tones for transmission of said at least one first pilot symbol during a second dwell of the subframe.

17. The method of claim 16, comprising selecting at least one fifth tone from the plurality of orthogonal tones for transmission of data associated with said at least one first pilot symbol during the second dwell of the subframe.

18. The method of claim 17, wherein receiving said at least one first pilot symbol during the second dwell of the subframe comprises receiving, during the second dwell of the subframe at least one second pilot symbol associated with data transmitted using at least one sixth tone selected from the plurality of orthogonal tones.

19. The method of claim 18, wherein receiving said at least one first pilot symbol and said at least one second pilot symbol during the second dwell of the subframe comprises receiving said at least one first pilot symbol and said at least one second pilot symbol on a timeshared basis.

20. The method of claim 10, wherein receiving said at least one first pilot symbol comprises receiving at least two first pilot symbols using at least two first tones, said at least two first pilot symbols being associated with data transmitted by a first mobile unit using said at least one second tone.

21. The method of claim 10, comprising determining at least one power control instruction based on said at least one first pilot symbol.

22. The method of claim 21, comprising providing information indicative of said at least one power control instruction.
